(19) United States
(12) Patent Application Publication
(10) Pub. No.: US 2020/0406190 A1
(43) Pub. Date: Dec. 31, 2020

(54) ELECTRICAL CONNECTOR ATTACHED TO AN ELONGATED CONDUCTIVE ELEMENT, IN PARTICULAR FOR AN EXHAUST GAS PURIFICATION DEVICE

(71) Applicant: FAURECIA SYSTEMES D'ECHAPPEMENT, NANTERRE (FR)

(72) Inventors: Guillaume AUFRANC, COURCELLES-LES-MONTBELIARD (FR); Jean-Paul BRUNEL, MESLIERES (FR)

(21) Appl. No.: 16/907,618

(22) Filed: Jun. 22, 2020

(30) Foreign Application Priority Data
Jun. 28, 2019 (FR) 19 07170

(51) Int. Cl. B01D 53/94; H01R 43/20; H01R 13/502; F01N 3/20

(52) U.S. Cl. CPC B01D 53/94; F01N 3/2013; H01R 13/502; H01R 43/20

(57) ABSTRACT

An electrical connector is secured to an elongated conductive element, and extends in a longitudinal direction between a first connection end and a second end from which the elongated conductive element extends. The electrical connector comprises a longitudinal passage in which the longitudinal conductive element partially extends up to the first connection end. The elongated conductive element is secured to the electrical connector at this first connection end.

### CROSS REFERENCE TO RELATED APPLICATIONS

This application is a U.S. non-provisional application claiming the benefit of French Application No. FR 19 07170, filed on Jun. 28, 2019, which is incorporated herein by its entirety.

### TECHNICAL FIELD

The present disclosure relates to an electrical connector secured to an elongated conductive element. Such an electrical connector is, for example, intended to equip an exhaust gas purification device equipping an exhaust line of a combustion engine, in particular in a motor vehicle, or any other vehicle, or for any other application.

### BACKGROUND

In the case of an exhaust gas purification device, the elongated conductive element equips a heater of the purification device. Indeed, such a purification device typically includes a purification unit, the latter, as well as the exhaust gases, being heated by the heater, in order to optimize the catalytic conversion of the polluting gases.

For reasons related to the assembly of the purification device, the electrical connector is generally secured to the elongated conductive element while the latter is already arranged in the purification device. As a result, this securing is sometimes difficult, the access to the junction zone between the electrical connector and the elongated conductive element being limited.

### SUMMARY

The disclosure in particular aims to facilitate the securing between an electrical conductor and an elongated conductive element.

It will be noted that although the context described above is that of a purification device, the disclosure is more generally applicable to any conceivable device requiring an electrical connector secured to an elongated conductive element, and more specifically when the junction zone between this electrical connector and this elongated conductive element is difficult to access or inaccessible.

Thus, the disclosure relates to an electrical connector secured to an elongated conductive element, the electrical connector extending in a longitudinal direction between a first connection end and a second end from which the elongated conductive element extends. The electrical connector comprises a longitudinal passage in which the longitudinal conductive element partially extends up to the first connection end, the elongated conductive element being secured to the electrical connector at this first end.

Owing to the disclosure, the securing is done at the first end of the electrical connector, which is easily accessible outside the device, rather than at the second end of the electrical connector, which is difficult to access or inaccessible.

An electrical connector according to the disclosure may further include one or more of the following features, considered alone or according to all technically possible combinations.

The elongated conductive element includes a first part extending in the electrical connector between the second end and the first connection end of the electrical connector, and a second part extending outside the electrical connector from the second end of the electrical connector, the second part of the elongated conductive element being at least partially covered with electrically insulating sheath.

The elongated conductive element is secured to the first connection end of the electrical connector by soldering, welding or crimping.

The longitudinal passage emerges at the second end of the electrical connector through a flared mouth.

The longitudinal passage includes a first segment and a second segment, the first segment extending between the first connection end and the second segment, the second segment extending between the first segment and the second end, the first segment being narrower than the second segment.

The electrical connector comprises a central part in which the longitudinal passage is arranged, an outer part with flange ring intended to cooperate with the case, and an intermediate assembly inserted radially between the central part and the outer part with flange ring, the intermediate assembly including at least one electrically insulating part, so as to electrically insulate the central part from the outer part with flange ring.

The disclosure also relates to a method for manufacturing the electrical connector as previously defined, the method including:

i. a step for making the longitudinal passage in the connector;

ii. a step for inserting the elongated conductive element in the longitudinal passage, from the second end toward the first connection end, and

iii. a step for securing the elongated conductive element with the electrical connector to the first connection end.

The disclosure also relates to an exhaust gas purification device including a heater comprising at least one elongated conductive element. An electrical connector is secured to the elongated conductive element, as previously defined.

Advantageously, the elongated conductive element is wound in a coil around a purification unit of the purification device, the purification unit incorporating inductive elements.

The disclosure lastly relates to a transportation vehicle, in particular a motor vehicle, including an exhaust line. The exhaust line includes a purification device as previously defined.

### BRIEF DESCRIPTION OF THE DRAWINGS

Various aspects and advantages of the disclosure will the highlighted in the following description, provided solely as a non-limiting example and done in reference to the appended figures, in which:

FIG. 1 is a longitudinal sectional view of a connector according to a first exemplary embodiment of the disclosure;

FIG. 2 is a partial longitudinal sectional view of an exhaust gas purification device, comprising the connector of FIG. 1;

FIG. 3 is a view similar to FIG. 1 of a connector according to a second exemplary embodiment of the disclosure. FIG. 1 shows an electrical connector 10 according to a first exemplary embodiment of the disclosure.

### DETAILED DESCRIPTION

In the described example, an electrical connector 10 equips an exhaust gas purification device 11. In a variant, however, it could equip any conceivable device requiring an electrical connector.

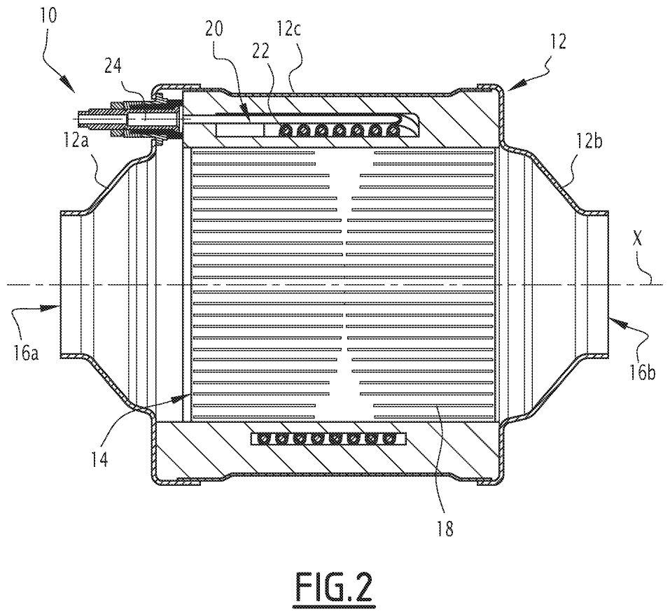

The purification device 11 is shown in FIG. 2. The purification device 11 is configured to be arranged in a combustion engine exhaust line, for example in a vehicle or in a stationary installation.

The purification device 11 includes an outer housing case 12 of a conventional type, extending in a longitudinal direction, that is to say, parallel to a longitudinal axis X.

The purification device 11 further includes a purification unit 14, housed in the outer housing case 12.

The outer housing case 12 advantageously includes a flared inlet part 12a, for example frustoconical, widening from an inlet opening 16a toward the purification unit 14. This flared inlet part 12a is configured to be connected to an upstream pipe of the exhaust line.

In a variant, the diameter of the upstream pipe is substantially equal to that of the purification unit, in which case the outer housing case 12 does not include a flared inlet part.

The outer housing case 12 also advantageously includes a flared outlet part 12b, for example frustoconical, widening from an outlet opening 16b toward the purification unit 14. This flared outlet part 12b is configured to be connected to a downstream pipe of the exhaust line.

In a variant, the diameter of the downstream pipe is substantially equal to that of the purification unit, in which case the outer housing case 12 does not include a flared outlet part.

The outer housing case 12 lastly includes an intermediate part 12c extending, in the longitudinal direction, between the inlet 12a and outlet 12b parts. The intermediate part 12c, for example, has a general shape of revolution around the longitudinal axis X. This intermediate part 12c surrounds the purification unit 14.

Thus, the exhaust gases are configured to circulate in the outer case 12, from the inlet opening 16a to the outlet opening 16b, while passing through the purification unit 14.

The outer housing case 12 is preferably made from a nonmagnetic metal, preferably a nonmagnetic steel, for example an austenitic stainless steel.

The purification unit 14 incorporates at least one inductive element 18, preferably a plurality of inductive elements 18. It will be recalled that an inductive element is an element in which an electric current is induced when it is subjected to a magnetic field.

The inductive elements 18 are for example metal rods, arranged parallel to one another, and parallel to the longitudinal axis X.

The purification unit is for example made from cordierite.

In order to subject the inductive elements 18 to a magnetic field, the purification device 10 includes an induction device 20, housed in the outer case 12 and surrounding the purification unit 14. In other words, the induction device 20 is positioned radially between the purification unit 14 and the intermediate part 12c of the outer case 12.

It will be recalled that an induction device 20 is a device able to generate a magnetic field.

In the described example, the induction device 20 includes a coil surrounding the purification unit 14. This coil is formed by an elongated conductive element 22 wound while surrounding the purification unit 14.

The elongated conductive element 22 extends between two electrical connectors 10, one of which is visible in FIG. 2. The elongated conductive element 22 is connected, at each of its ends, to a respective one of these two electrical connectors 10.

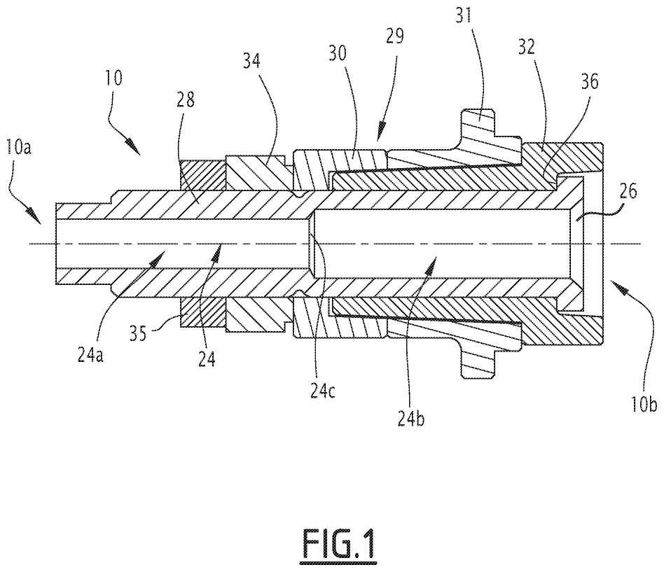

The electrical connector 10, shown in FIG. 1, will be described below in more detail. The other electrical connector is identical, such that the description of the electrical connector 10 will also be valid for the other electrical connector.

Each electrical connector 10 passes through the outer case 12, for example the inlet part 12a, so as to be accessible from outside the purification device 10, to be able to be coupled to an electrical power source. Each electrical connector 10 is secured, preferably welded, to the case 12.

Each electrical connector 10 extends in the longitudinal direction, parallel to the longitudinal axis X.

In one variant that is not shown, the electrical connector 10 can extend in another direction, for example a radial direction perpendicular to the longitudinal axis X. However, the solution in which the electrical connectors 10 extend in the longitudinal direction is preferred, since it is easier to implement.

Advantageously, each electrical connector 10 is radially offset relative to the purification unit 14, that is to say, it does not extend across from this purification unit 14 in the longitudinal direction. Thus, each electrical connector 10 is arranged near the periphery of the outer case 12.

The electrical connector 10 extends in the longitudinal direction between a first connection end 10a, outside the case 12, intended to be connected to a complementary element in a conventional manner, and a second end 10b, inside the case 12. The elongated conductive element 22 extends in the case 12 past this second end 10b, as shown in FIG. 2.

According to the disclosure, the electrical connector 10 includes a central longitudinal passage 24, extending in the longitudinal direction between the first 10a and second 10b ends of the electrical connector 10.

The elongated conductive element 22 extends partially in this longitudinal passage 24, up to the first end 10a. The elongated conductive element 22 is then secured with the electrical connector at this first end 10a, for example by welding or by crimping, or preferably by soldering.

Advantageously, the elongated conductive element 22 being subdivided into a first part extending in the electrical connector 10 between the second 10b and first 10a end of the electrical connector, and a second part extending outside the electrical connector 10 from the second end 10b of the electrical connector 10, the second part of the elongated conductive element 22 is at least partially covered with electrically insulating sheath.

It will be noted that, when the elongated conductive element 22 is assembled with the electrical connector 10, the elongated conductive element 22 is inserted into the longitudinal passage 24 from the second end 10b of the electrical connector 10. In order to facilitate this insertion, the longitudinal passage 24 preferably emerges at the second end 10b of the electrical connector through a flared mouth 26. Of course, the mouth 26 is flared by widening from the inside of the longitudinal passage 24 toward the outside, to facilitate the insertion of the elongated conductive element 22 in the longitudinal passage 24.

Furthermore, still in order to facilitate the insertion of the elongated conductive element 22 into the longitudinal passage 24, the longitudinal passage 24 is wider on the side of the second end 10b. In other words, the longitudinal passage 24 includes a first segment 24a and a second segment 24b, with different widths. The first segment 24a extends between the first end 10a and the second segment 24b, and the second segment 24b extends between the first segment 24a and the second end 10b. The first segment 24a has a first section in a first transverse plane perpendicular to the longitudinal direction, and the second segment 24b has a second section in a second transverse plane parallel to the first transverse plane. The first section defines a first area, and the second section defines a second area, such that the first area is smaller than the second area. More specifically, in the case where the first and second sections are circular, the first section has a diameter smaller than that of the second section.

The first 24a and second 24b segments are separated by a flared shoulder 24c, which becomes wider from the first segment 24a toward the second segment 24b.

In the described example, the electrical connector 10 is formed by several parts assembled to one another, namely a central part 28 in which the longitudinal passage 24 is arranged, an outer part with flange ring 31, and an intermediate assembly 29 radially inserted between the central part 28 and the outer part with flange 31.

In the described example, the intermediate assembly 29 includes an outer part 30, and an intermediate part 32.

The outer part with flange ring 31 is intended to cooperate with an edge of an opening arranged in the case 12, in which the electrical connector 10 is arranged. In this embodiment, the intermediate part 32 is inserted radially between the outer part with flange ring 31 and the central part 28.

At least one of the outer 30 and intermediate 32 parts is preferably made from an electrically insulating material, so as to electrically insulate the central part 28 from the outer part with flange ring 31. Preferably, any intermediate assembly (therefore the outer part 30 and the intermediate part 32) is made from an electrically insulating material.

To that end, the outer 30 and intermediate 32 parts are, for example, made from ceramics such as aluminum oxides, glass, or any other good electrical insulator (having a resistivity greater than 10¹² am, and a dielectric strength greater than 30 kV/mm at 20° C.) and withstanding temperatures on the order of 500° C.

The intermediate part 32 includes an inner surface cooperating with a complementary surface of the central part 28. This inner surface and this complementary surface are preferably cylindrical with generators parallel to the longitudinal direction.

The intermediate part 32 also includes an outer surface cooperating with a complementary surface of the outer part 30 and the outer part with flange ring 31. The outer surface is frustoconical, inclined relative to the longitudinal direction, such that, when the intermediate part 32 is gripped against the outer part 30 in the longitudinal direction, the intermediate part 32 is radially pinched between the outer part 30 and the central part 28. Furthermore, the outer part with flange ring 31 is longitudinally gripped between the outer part 30 and a shoulder of the intermediate part 32.

In order to perform this gripping, the electrical connector 10 includes a nut 34 screwed on a threaded part of the central part 28 and cooperating with the outer part 30 to push it toward the intermediate part 32. The intermediate part 32 also abuts with a shoulder 36 arranged at one end of the central part 28, on the side of the second end 10b. Thus, when the nut 34 is tightened, the outer part 30 is gripped between this nut 34 and the outer part with flange ring 31, the outer part with flange ring 31 is gripped between the outer part 30 and the intermediate part 32, and the intermediate part 32 is gripped between the outer part with flange ring 31 and the shoulder 36.

It will be noted that the intermediate assembly 30, 32 also makes it possible to electrically insulate the nut 34 of the outer part with flange ring 31.

It will also be noted that in a variant, the outer part with flange ring 31 could also be made from an electrically insulating material.

Conversely, the central part 28 is made from an electrically conductive material. Indeed, the electrical connection is done via this central part 28. Preferably, the nut 34 is also made from an electrically conductive material.

Preferably, a second nut 35 is screwed on the central part 28, so as to be gripped against the nut 34, so as to grip an electrical supply element (not shown) between the nut 34 and the second nut 35. This electrical supply element is thus electrically connected to the central part 28, therefore to the elongated conductive element 22.

The electrical supply element is, for example, an electrical lug.

It will be noted that other connection modes are possible in a variant. For example, the central part 28 is in the form of a male plug intended to cooperate with a female plug. For example, it is possible to consider connection modes of the switch-hole, screw-clip, etc. type.

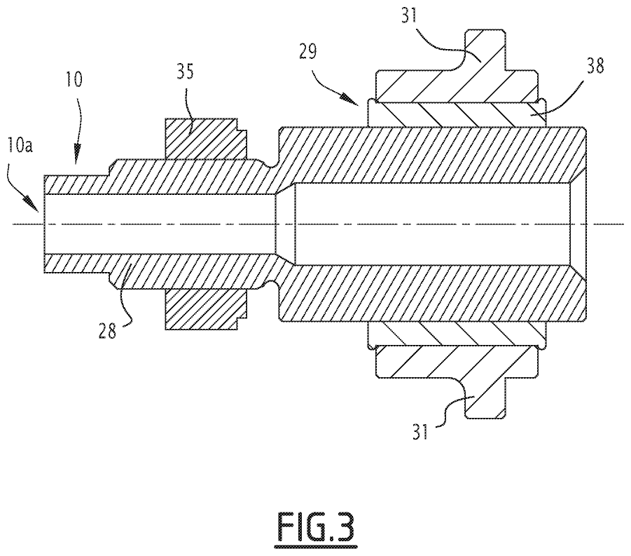

FIG. 3 shows an electrical connector 10 according to a second exemplary embodiment of the disclosure. In this figure, the elements similar to those of the first embodiment are designated by identical references.

According to this second embodiment, the intermediate assembly 29 is formed by a single piece, formed by a ring 38 inserted between the outer part with flange ring 31 and the central part 28.

The ring 38 is preferably made from an electrically insulating material, so as to electrically insulate the central part 28 from the outer part with flange ring 31.

To that end, the ring 38 is, for example, made from ceramic such as aluminum oxide, glass, or any other good electrical insulator (having a resistivity greater than 10¹² am, and a dielectric strength greater than 30 kV/mm at 20° C.) and withstanding temperatures on the order of 500° C.

It will be noted that, in this second embodiment, the electrical connector 10 only includes said second nut 35, intended to be gripped against a shoulder of the central part 28, to grip an electrical supply element between this second nut and this shoulder.

Like in the first embodiment, the electrical supply element is for example an electric lug.

It will be noted that the disclosure is not limited to the embodiments previously described, but could take the form of various additional variants without going beyond the scope of the claims.

For example, the disclosure could be applied to an exhaust gas purification device with heating grid, in which case the elongated conductive element would be a power cable of the heating grid.

It will be recalled that the disclosure may also be applied to any device requiring an electrical connector.

Although various embodiments have been disclosed, a worker of ordinary skill in this art would recognize that certain modifications would come within the scope of this disclosure. For that reason, the following claims should be studied to determine the true scope and content of this disclosure.

1. An electrical connector apparatus comprising:
an electrical connector secured to an elongated conductive element, the electrical connector extending in a longitudinal direction between a first connection end and a second end from which the elongated conductive element extends; and
wherein the electrical connector comprises a longitudinal passage in which the longitudinal conductive element partially extends up to the first connection end, the elongated conductive element being secured to the electrical connector at this first connection end.

2. The electrical connector apparatus according to claim 1, wherein the elongated conductive element includes a first part extending in the electrical connector between the second end and the first connection end of the electrical connector, and a second part extending outside the electrical connector from the second end of the electrical connector, the second part of the elongated conductive element being at least partially covered with electrically insulating sheath.

3. The electrical connector apparatus according to claim 1, wherein the elongated conductive element is secured to the first connection end of the electrical connector by soldering, welding, or crimping.

4. The electrical connector apparatus according to claim 1, wherein the longitudinal passage emerges at the second end of the electrical connector through a flared mouth.

5. The electrical connector apparatus according to claim 1, wherein the longitudinal passage includes a first segment and a second segment, the first segment extending between the first connection end and the second segment, the second segment extending between the first segment and the second end, the first segment being narrower than the second segment.

6. The electrical connector apparatus according to claim 1, comprising a central part in which the longitudinal passage is arranged, an outer part with flange ring intended to cooperate with an outer housing case, and an intermediate assembly inserted radially between the central part and the outer part with flange ring, the intermediate assembly including at least one electrically insulating part to electrically insulate the central part from the outer part with flange ring.

7. A method for manufacturing an electrical connector secured to an elongated conductive element, the electrical connector extending in a longitudinal direction between a first connection end and a second end from which the elongated conductive element extends, the electrical connector comprising a longitudinal passage in which the longitudinal conductive element partially extends up to the first connection end, the elongated conductive element being secured to the electrical connector at this first connection end, wherein the method includes:
making the longitudinal passage in the electrical connector;
inserting the elongated conductive element in the longitudinal passage, from the second end toward the first connection end, and
securing the elongated conductive element with the electrical connector to the first connection end.

8. An exhaust gas purification device, including:
a heater comprising at least one elongated conductive element, wherein the exhaust gas purification device includes an electrical connector secured to the elongated conductive element, the electrical connector extending in a longitudinal direction between a first connection end and a second end from which the elongated conductive element extends, the electrical connector comprising a longitudinal passage in which the longitudinal conductive element partially extends up to the first connection end, the elongated conductive element being secured to the electrical connector at this first connection end.

9. The exhaust gas purification device according to claim 8, wherein the elongated conductive element is wound in a coil around a purification unit of the exhaust gas purification device, the purification unit incorporating inductive elements.

10. A transportation vehicle, in particular a motor vehicle, including:
an exhaust line that includes an exhaust gas purification device including a heater comprising at least one elongated conductive element, the exhaust gas purification device including an electrical connector secured to the elongated conductive element, the electrical connector extending in a longitudinal direction between a first connection end and a second end from which the elongated conductive element extends, the electrical connector comprising a longitudinal passage in which the longitudinal conductive element partially extends up to the first connection end, the elongated conductive element being secured to the electrical connector at this first connection end.
